(19) United States
(12) Patent Application Publication
(10) Pub. No.: US 2022/0369434 A1
(43) Pub. Date: Nov. 17, 2022

(54) ELECTROMAGNETIC HEATING REACTOR

(71) Applicant: C-Tech Innovation Limited, Chester (GB)

(72) Inventors: Robert BELL, Chester (GB); Mark ROBBINS, Chester (GB)

(21) Appl. No.: 17/621,352

(22) PCT Filed: Jun. 19, 2020
(86) PCT No.: PCT/GB2020/051499

§ 371 Date: Dec. 21, 2021

(30) Foreign Application Priority Data
Jun. 21, 2019 (GB) 1908940.8

(51) Int. Cl. H05B 6/80

(52) U.S. Cl. CPC H05B 6/806

(57) ABSTRACT

An electromagnetic heating reactor for heating a fluid stream contained within a supply conduit that is microwave and/or radio frequency, RF, transparent or substantially or partially transparent, in a microwave enclosure formed substantially of a conducting material. The cross-section area of the enclosure is not constant transverse to the fluid conduit and in which the fluid is continuously moved through the cavity to increase the temperature.

### BACKGROUND OF THE INVENTION

### 1. Field of the Invention

The present invention relates to an electromagnetic heating reactor used for carrying out continuous chemical reactions. The electromagnetic radiation used is either radio frequency or microwave radiation and the invention is of relevance to several applications including carrying out chemical reactions in chemicals, fine chemicals, pharmaceutical, food, mining, and other sectors.

### 2. The Prior Art

Dielectric heating using microwave or Radio Frequency energy (RF) can provide a thermal energy input to chemical reactions as an alternative to jacketed vessels, heat exchangers and other means. RF and microwave heating are volumetric heating techniques which heat materials directly and without the requirement for energy to be transferred to the reagents by thermal conduction from an external source or medium. This confers advantages regarding attainable rates of heating over conventional means of heating chemical reactions and the technique finds applications in diverse sectors.

Microwave radiation is that part of the electromagnetic spectrum with a wavelength range from about 1 mm to about 1 m. This overlaps to some extent with the RF range which is typically defined as radiation with wavelengths between 0.4 m and 20 m. In any case, dielectric or electromagnetic heating may be described as both microwave and RF heating.

Microwave transparent tubes are typically used to contain the process fluid within an outer microwave cavity. Fluoropolymers, glass, quartz, ceramics, sapphire, PEI, PP, PE, and other nominally microwave transparent materials are suitable for this purpose and can be used to provide a conduit to pass the fluids through the microwave cavity.

Microwave and RF electromagnetic containment requires an electrically conductive enclosure (the microwave cavity) having a robust metallic skin of sufficient thickness to reliably carry skin currents. Furthermore, high power application of dielectric energy requires rigorous and robust electromagnetic screening.

The degree to which materials absorb microwave radiation is determined by the dielectric constant of the material. Most materials of interest in this context have a dielectric constant that varies with temperature. At the same time, the dielectric constant of materials within a microwave cavity influences the distribution of field strength within the cavity. Unless steps are taken to mitigate the effect, the heating of a fluid passing through a microwave cavity can become uneven with hot spots forming. This compromises the quality of the product and the safety of the process. The design of continuous microwave chemical reactors seeks to reduce or eliminate the effect. Two approaches are known which address the requirement for even heating of the process fluid and the avoidance of hot spots. One approach makes use of a mono-mode microwave cavity and the other a multi-mode microwave cavity.

In a mono-mode microwave cavity, microwaves are contained as a standing wave within a wave guide having dimensions selected such that a single mode of electromagnetic radiation propagates within the cavity. The cavity is resonant at the frequency of application and the resonant condition is achieved by means of devices such as sliding shorts which adjust the dimension of the cavity. The advantage of a mono-mode cavity is that the electromagnetic field strength within the cavity is fixed and an even heating effect is obtained. The disadvantage is that different reaction materials with different dielectric properties change the resonant condition and the system must be tuned for each chemical system.

Multi-mode cavities on the other hand do not feature a standing wave and are not resonant at the frequency of operation. The cavity is not of dimensions that correspond to those necessary to propagation a standing wave. Additional devices such as mode-stirrers may be included within a multi-mode cavity. A mode-stirrer is a rotating device that disrupts the electromagnetic field pattern and evens out the electromagnetic field strength. The advantage of a multi-mode cavity is that it does not require tuning and is insensitive to the dielectric properties of the process material. The disadvantage of the multi-mode cavity is that for a given power input the requirement for even heating means that the path length of the process fluid within the cavity has to be longer than it is in the case of the mono-mode cavity, sometimes significantly longer. This longer flow-path gives a longer transit time and increases the difficulty of controlling the temperature at the output.

The use of microwave radiation for the purposes of carrying out a continuous flow chemical reaction in a multi-mode cavity is described by CABLEWSKI, et al. Development and application of a continuous microwave reactor for organic synthesis. J. Org. Chem. 1994, no. 59, p. 3408-3412. This paper describes pumping a reaction mixture through a tube contained within a microwave cavity, followed by passing the reaction mixture through a heat exchanger and pressure control system. This paper notes that it is difficult to obtain a uniform energy distribution and to control and monitor temperature within the microwave cavity and that metering and control devices were fitted in an attempt to overcome those problems. The cavity in this case is not resonant at the supply frequency and is not a mono-mode cavity.

Another example of a multi-mode cavity is described in patent application WO 2009/048642 A (ACCELBEAM DEVICES LLC ET AL) 16 Apr. 2009 which discloses a microwave reactor which consists of an unpressurised microwave cavity, of uniform and circular cross-section and containing a series of tubes through which the reaction medium passes and one or more microwave antenna. The arrangement is said to provide uniformly and homogeneously propagated radiation in the chamber and that is evenly absorbed by the reaction mixture. Similar arrangements with multiple heating zones are described in patent US 2014264171 A (SHOEI ELECTRONIC MATERIALS INC) 18 Sep. 2014 18.09.2014.

EP 2419207 A (C TECH INNOVATION LTD) 22 Feb. 2012 describes a mono-mode continuous flow microwave chemical reactor. It includes a description of a general arrangement of a flow path for chemicals which passes through a microwave guide tube and the detail of arrangements for maintaining effective containment of microwave radiation at the entry and exit points for the chemical flow path in and out of the microwave cavity.

A mono-mode continuous heater is disclosed US 2004155034 A (FEHER ET AL) 12 Aug. 2004 12.08.2004. The patent describes a continuous flow microwave heater for heating a fluid including a microwave source connected to an applicator so as to supply microwave energy to the applicator, the applicator being a rectangular block-like resonator space with opposite front walls and side walls with a microwave in-coupling opening in one of the side walls through which the microwave energy is supplied to the resonator space in which a linearly polarized base mode TE10 is excited.

CH 544477 A (NESTLE SA) 15 Nov. 1973 describes a mono-mode cavity with arrangements intended to allow the system to operate with variable dielectric materials. Liquid is heated by passage through a preferably cylindrical waveguide via a serpentine coil, or in containers moving on a conveyor belt of “Teflon”. Microwave radiation, preferably at a frequency of about 2450 MHz is fed to a rectangular waveguide which may have a piston to vary coupling, (according to liquid dielectric), and passes through apertures to the cylindrical waveguide, where resonance occurs in TE01 mode, with nodes occurring at the walls, and antinodes at about half the radius coincident with the liquid feed. High efficiency heating is produced, with minimal leakage of radiation.

US 2019029084 A (INOVFRUIT) 12 Jan. 2019 describes a mono-mode microwave applicator device and method for the thermal treatment of a particulate material by exposure to microwave radiation in a cavity which is designed for single-mode propagation, for an implemented microwave frequency, and a means of transporting the particulate product in a continuous flow following the longitudinal direction of the cavity of the exposure waveguide.

US 2012088885 A (KRULL ET AL) 12 Apr. 2012 describes an apparatus for continuously performing a chemical reaction, comprising a microwave generator, a mono-mode microwave applicator with a microwave-transparent tube within, and an isothermal reaction zone, which are arranged such that the longitudinal axis of the microwave-transparent tube is in the direction of propagation of the microwaves in the mono-mode microwave applicator, and that a reaction mixture in the microwave-transparent tube is conducted through the mono-mode microwave applicator as a heating zone, within which the reaction mixture is heated to reaction temperature by means of microwaves which are conducted out of the microwave generator into the mono-mode microwave applicator, and wherein the heated and the optionally pressurized, reaction mixture is transferred immediately after leaving the heating Zone into the isothermal reaction Zone adjoining the heating Zone and, after leaving the isothermal reaction Zone, the reaction mixture is cooled down.

None of the many configurations of continuous flow microwave chemical reactor that are known provide for a short path length of process fluid and high intensity heating in a device that does not require retuning when different process fluids are used. Designs which feature a short flow path and residence time in the microwave field and the most effective control of microwave power and temperature output have up to now featured the use of a mono-mode cavity and the consequent requirement for tuning.

### SUMMARY OF THE INVENTION

According to the present invention an electromagnetic heating reactor electromagnetic heating reactor an electromagnetic heating reactor for heating a fluid stream flowing continuously through a conduit within a microwave cavity is characterised in that the microwave cavity has a first rectangular cross-section at one end where fluid enters the cavity and a larger second rectangular cross-section at the other end of the cavity where fluid leaves the cavity and a continuously increasing cross-sectional area along its length to the larger second rectangular cross section, and in that length of all of the sides of the larger second rectangular cross-section are equal to or greater than that of the longer of the sides of the first rectangular cross-section.

In one embodiment the second rectangular cross section is square.

The present invention thus provides an electromagnetic heating reactor comprising an electromagnetic enclosure comprising conducting material arranged such that electromagnetic energy enters the enclosure at one end, either by means of a waveguide connection or by antenna coupling, and interacts with fluid flowing through microwave transparent fluid conduit within the microwave cavity.

This invention allows for short fluid path lengths, rapid and effective power input, and temperature control without the need to be tuned to achieve resonant conditions for different process fluids. This allows both even heating and a simplicity of operation that does not require a sliding short to change the dimensions of the cavity. Further that a reactant supply conduit is at least partially or wholly enclosed within the enclosure.

Surprisingly, it has been found that the heating performance of the reactor is improved by replacing the conventionally used constant cross-section parallel-sided waveguide hollow conductor with a novel waveguide hollow conductor design which has a non-constant cross-section. This novel hollow conductor or waveguide has a rectangular cross-section at one end and a significantly larger rectangular or square cross-section at the other end, and a continuously changing cross-section along its length. The length of all of the sides of the larger cross-section at one end of the hollow conductor is equal to or greater than that of the longer of the sides of the smaller rectangular cross-section at the other end of the conductor.

When the longest side of the first rectangular cross-section is shorter than all of the sides of the second rectangular cross-section then the microwave cavity conductor has side faces comprising two congruent isosceles trapezoids on opposite sides, and two other congruent isosceles trapezoids on the other two opposing faces.

When the longest side of the first rectangular cross-section is the same length as the two sides of the second rectangular cross section parallel to the longest side of the first rectangular cross-section then the microwave cavity has side faces comprising two congruent isosceles trapezoids on opposite sides, and congruent rectangular faces on the two opposing faces.

### SUMMARY OF DRAWINGS

FIG. 1 shows one example heating reactor according to the invention;

FIG. 2 illustrates the geometric arrangement of the microwave cavity of FIG. 1; and

FIG. 3 shows a comparison of heating performance between two enclosures of similar length with the preferred geometry of the enclosure with increasing cross section and an enclosure with a consistent cross section.

### DETAILED DESCRIPTION OF THE PREFERRED EMBODIMENTS

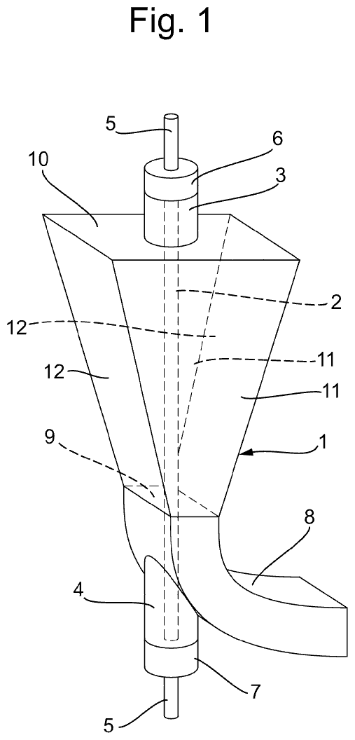

In FIG. 1, a microwave cavity 1 has a varying cross-section such that it is not resonant and is not mono modal. A conduit 2 contains the chemical product in the form of a fluid to be heated. The fluid flows through the conduit 2 from the bottom to the top of the microwave cavity 1 as shown in FIG. 1, in the same direction of travel as the microwave radiation in the cavity. The conduit 2 is microwave transparent for that part within the microwave cavity. The conduit 2 has joints and seals 3 and 4 to join the conduit 2 to external metallic pipes 5. Housing structures 6 and 7 are connected to an external frame and support the conduit 2. A waveguide 8 connects the cavity to a microwave generator source.

The microwave cavity has a rectangular cross-section at the end 9 where the conduit 2 and fluid enters the microwave cavity 1 and a square cross-section at the other end 10 where the conduit and fluid therein leave the microwave cavity. The microwave cavity has an increasing cross-section along its length between the end 9 and end 10. The length of the sides of the square cross-section at the end 10 of the microwave cavity is equal to or greater than that of the longer of the sides of the rectangular cross-section at the other end of the conductor. The cross section of the microwave cavity at the end 9 is the smallest and is a rectangle whose longest dimension is equal to the length of the sides of the square cross-section at end 10 of the microwave cavity. Thus, one pair of opposite faces 11 of the microwave cavity 1 comprises two congruent isosceles trapezoids and the other pair of opposite faces 12 of the microwave cavity 1 comprises congruent rectangles.

The inventors have found that good results are obtained if the cross-sectional area of the enclosure varies by a least 40% between the smallest and largest cross sections transverse to the fluid conduit path and best results if the cross-sectional area of the enclosure varies by a least 60% between the smallest and largest cross sections transverse to the fluid conduit path.

The conduit 2 is connected by the joints and seals 3 and 4 outside the microwave cavity to prevent the fluid chemical reactants from contaminating or attacking the interior of the electromagnetic microwave cavity.

Conduit 2 is at least partially transparent at microwave and/or radio frequency wavelengths. A suitable material can be selected from the group comprising glass, silica, polymer, PTFE, quartz, and sapphire.

Although in the description of FIG. 1 the external pipes 5 are of metal with connections 3 and 4 to conduit 2, conduit 2 may extend externally beyond the microwave cavity and the extension be coated with a metal or other conductive material, the pipes 5 coated with a polymer, such as PTFE or other for corrosion resistance. Optionally, the electromagnetic heating reactor may be arranged to provide electromagnetic energy at different frequencies separately or simultaneously.

The normal fluid to be heated would be liquid or substantially a liquid; preferably the fluid should have a dielectric constant of 2.1 or higher. Optionally, the electromagnetic heating reactor may be arranged to provide electromagnetic energy from about 100 W to 120 kW, but the inventors have found that the ideal range is between 100 W and 100 kW.

Optionally, the electromagnetic heating reactor may be further arranged to provide pulsed or continuous wave electromagnetic radiation.

The electromagnetic heating reactor should be arranged to provide electromagnetic energy at a frequency anywhere between 13 MHz and 300 GHz but ideally between 800 MHz and 4000 MHz.

Optionally, the conduit 2 within the electromagnetic enclosure may be coiled. This may increase the time the reactant is exposed to electromagnetic energy and/or allow a faster flow of fluid reactant through the conduit 2 and reduce the overall size of the reactor.

Optionally, the electromagnetic heating reactor may be further arranged to maintain reactant within the reactant supply conduit up to 300° C. and further up to 1000° C. by using high temperature materials such as quartz, ceramics, or other such high temperature materials, for instance. The lower range temperatures may be used for polymer reaction supply conduits and the high range temperatures may be used for quartz or ceramic based materials. Preferably, the reactant supply conduit may be pressurised between from 0.01 bar to 200 bar or higher. Elevated pressures may be used to prevent boiling of reactants. Alternatively, the reactant supply conduit may be operated at ambient or atmospheric pressure.

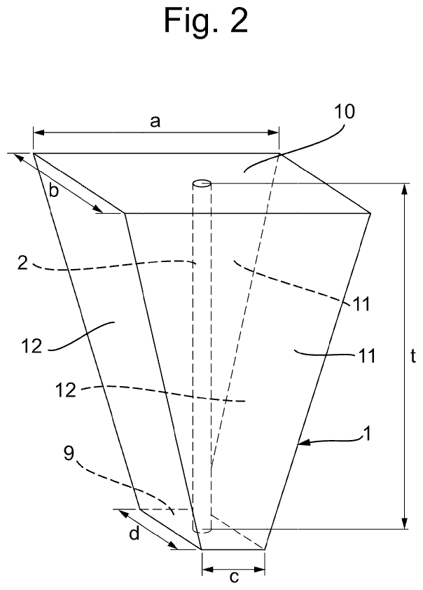

FIG. 2 illustrates the various dimensions associated with the microwave cavity 1 of FIG. 1.

The rectangular cross section at the end 9 where fluid enters the cavity 1 in conduit 2 is defined by sides with lengths the lengths “c” (the shorter side) and “d” (the longer side), and the square at the end 10 of the microwave cavity where fluid leaves a larger rectangle or square has sides of length “a” and “b”. The length of the cavity between the rectangle and the square is “t”, which is independent of the length “a” or “b” but is not usually less than the length “c”. In one embodiment “a” and “b” are both equal in length to “d”, but greater than “c”, resulting in the microwave cavity having a pair of opposed congruent trapezoid surfaces 11 and a pair of opposed congruent rectangular surfaces 12. In another embodiment, the lengths “a” and “b” are greater than “c” and “d” forming opposed pairs of surfaces 11 and 12 which are pairs of isosceles trapezoids, those of surface 11 being of a different geometry to those of 12 figure in FIG. 1.

The length of the reactor is governed by the flow conditions and the value of t between c to 100c is preferred with a preferable range of 5c and 15c.

### ILLUSTRATIVE EXAMPLES

The following examples are of heating processes using the equipment of FIG. 1.

### Example 1

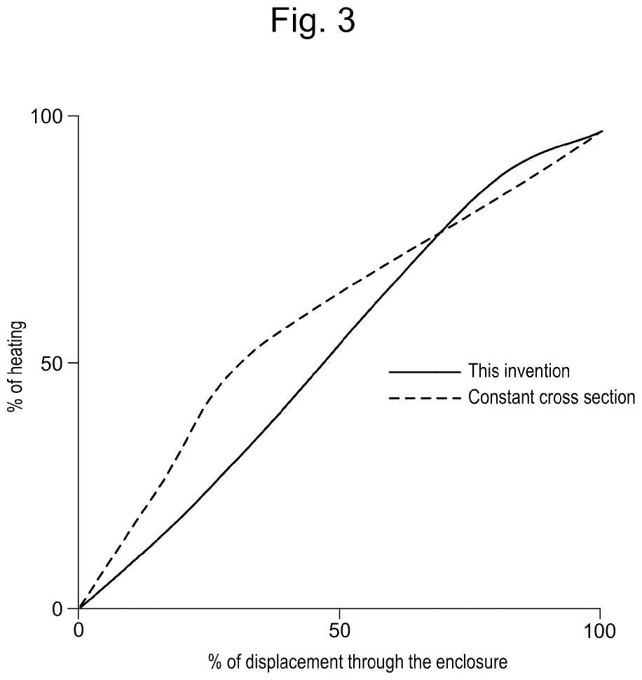

The results of example 1 are illustrated in FIG. 3.

A 1% saline solution was passed through a silica conduit located centrally in a microwave cavity at a fixed rate and the temperature was measured at fixed points through the reactor to monitor the change in temperatures. A comparison was conducted between a conventional heating reactor with a constant cross section and a reactor, as shown in FIG. 1, with a rectangular cross-section at one end and a square cross-section at the other end, and a continuously changing cross-section along its length. In both cases the dimensions of microwave cavity where the saline solution entered the microwave cavity and overall length of the cavity were identical. The frequency of the applied electromagnetic field was 2.45 GHz. The standard deviation of the rate of temperature increase was determined. A cavity with increasing cross section showed a reduction of 49% in the standard deviation for heating rate through the reactor, which is a significant improvement and allows better prediction of temperature profiles.

### Example 2

A 1% saline solution was passed through a silica conduit 2 located centrally in the microwave cavity at a fixed rate and the temperature was measured at fixed points through the reactor to monitor the change in temperatures. A comparison was conducted between a heating reactor with a constant cross section and a reactor with a rectangular cross-section at one end and a square cross-section and a continuously increasing changing cross-section along its length at the other end as shown in FIG. 1. In both cases the dimensions of the inlet and overall length were identical. The frequency of the applied electromagnetic field was 2.45 GHz. On average the reactor with constant cross section had an average energy transfer efficiency of 88.2%. The reactor with an increasing cross section achieved an average energy transfer efficiency of 96.3%

### Example 3

A reactor with a rectangular cross-section at one end and a square cross-section at the other end, and a continuously changing cross-section along its length at the other end as shown in FIG. 1 was in a heating application containing a stub tuner but no sliding short to change the dimensions of the cavity and a reactant supply conduit at least partially or wholly enclosed within the enclosure. A solution of 1% saline was passed through the reactor at a constant rate and the system was operated with zero reflected power and over 96% energy transferred into the solution. The solution was changed to ethylene glycol and the stub tuner altered and the system was able to function with zero reflected power and high energy transfer efficiency. This example illustrates that the invention avoids the need to be tuned for each chemical system.

1. An electromagnetic heating reactor for heating a fluid stream flowing continuously through a conduit within a microwave cavity, characterised in that the microwave cavity has a first rectangular cross-section at one end where fluid enters the cavity and a larger second rectangular cross-section at the other end of the cavity where fluid leaves the cavity and a continuously increasing cross-sectional area along its length to the larger second rectangular cross section, and in that length of all of the sides of the larger second rectangular cross-section are equal to or greater than that of the longer of the sides of the first rectangular cross-section.

2. The electromagnetic heating reactor according to claim 1 in which the larger second rectangular cross section is square.

3. The electromagnetic heating reactor according to claim 1 characterised in that the microwave power supplied is between 100 W and 120 kW.

4. The electromagnetic heating reactor according to claim 1 characterised in that length of the microwave cavity is between 1 and 100 times inclusive the length of the longer of the sides of the first rectangular cross-section.

5. The electromagnetic heating reactor according to claim 4 characterised in that the length of the microwave cavity is between 5 and 15 times inclusive that of the longer of the sides of the first rectangular cross-section.

6. The electromagnetic heating reactor according to claim 4 characterised in that the cross-sectional area of the microwave cavity increases by at least 40% between the first rectangular cross-section and the second rectangular cross-section.

7. The electromagnetic heating reactor according to claim 6 characterised in that the cross-sectional area of the microwave cavity increases by at least 60% between the first rectangular cross-section and the second rectangular cross-section.

8. The electromagnetic heating reactor according to claim 1 characterised in that the microwave cavity has a first pair of opposed pair of congruent trapezoid sides.

9. The electromagnetic heating reactor according to claim 7 characterised in that the microwave cavity has an opposed pair of congruent rectangular sides.

10. The electromagnetic heating reactor according to claim 7 characterised in that the microwave cavity has a second opposed pair of congruent trapezoid sides, said second pair not being congruent with the first pair.

11. The electromagnetic heating reactor according to claim 1 characterised in that the longer of the sides of the first rectangular cross-section is between 30% and 80% inclusive of the free space wavelength of the applied electromagnetic energy supply.

12. The electromagnetic heating reactor according to claim 1 wherein a dielectric constant of the fluid to be heated is 2.1 or more.

13. The electromagnetic heating reactor according to claim 1 having an electromagnetic energy supply in a range of frequencies from 800 MHz to 4000 MHz inclusive.
